(19) United States
(12) Patent Application Publication
(10) Pub. No.: US 2007/0140787 A1
(43) Pub. Date: Jun. 21, 2007

(54) Low profile cam latch assembly

(75) Inventors: David Frederick Champion, Durham, NC (US); Timothy Andreas Meserth, Durham, NC (US); Gerard Francis Muenkel, Raleigh, NC (US); Peter Andrew Smith, Cary, NC (US); Brian Alan Trumbo, Apex, NC (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, ARMONK, NY (US)

(21) Appl. No.: 11/304,135

(22) Filed: Dec. 15, 2005

(51) Int. Cl. B25G 3/18

(52) U.S. Cl. 403/321

(57) ABSTRACT

A low profile cam latch assembly is provided for use installation and removal of associated components into a rack or chassis. An elongated cam arm and a mating retainer are fixedly mounted to an associated component. The elongated cam arm includes a pivot mounted trigger member releasably engaged with the mating retainer to retain or lock the cam arm in a closed position. The elongated cam arm includes a recessed hook shape defined together with an outwardly extending finger grip with the cam are rotated out in an open position. The finger hook shape and finger grip are arranged for engagement by a thumb or finger of a user for removal of the associated component.

### FIELD OF THE INVENTION

The present invention relates generally to the mechanical connection field for data processing systems, and more particularly, relates to a low profile cam latch assembly used for the installation and removal of an associated removable component into a rack or chassis, such as within a data center and computer systems.

### DESCRIPTION OF THE RELATED ART

Various components require cam handle latches for installation and removal, such as blade servers, manufactured by International Business Machines Corporation. Blade servers fit in a single chassis like books in a bookshelf and each is an independent server, with its own processors, memory, storage, network controllers, operating system and applications. The blade server simply slides into a bay in the chassis and plugs into a mid-plane or backplane, sharing power, fans, floppy drives, switches, and ports with other blade servers.

Other components requiring cam handle latches for installation and removal include, for example, power supplies, Ethernet switches, system management units, blade storage units, fans, blowers, and various other components.

A need exists for an effective mechanism for installation and removal of removable components into a rack or chassis.

### SUMMARY OF THE INVENTION

A principal aspect of the present invention is to provide a low profile cam latch assembly for installation and removal of removable components into a rack or chassis. Other important aspects of the present invention are to provide such low profile cam latch assembly substantially without negative effect and that overcome many of the disadvantages of prior art arrangements.

In brief, a low profile cam latch assembly is provided for use installation and removal of associated components into a rack or chassis. An elongated cam arm and a mating retainer are fixedly mounted to an associated component. The elongated cam arm includes a pivot mounted trigger member releasably engaged with the mating retainer to retain or lock the cam arm in a closed position. The elongated cam arm includes a recessed hook shape defined together with an outwardly extending finger grip with the cam are rotated out in an open position. The finger hook shape and finger grip are arranged for engagement by a thumb or finger of a user for removal of the associated component.

In accordance with features of the invention, a contrasting color is added to the finger hook shape so that the hook and finger grip is enhanced visually. This color and the hook shape are visible only when the cam arm is rotated out.

In accordance with features of the invention, a locking tooth of the trigger member engages a mating surface of the mating retainer. The locking tooth of the trigger member clicks into place with audible and tactile indication that the trigger member has seated with the mating retainer. The locked or engaged trigger member keeps the cam arm from vibrating out of its locked or installed position.

In accordance with features of the invention, trigger member includes a grip feature formed near an anchor pivot point to the cam arm in a base portion of the trigger member. Trigger base portion extends generally parallel with an exterior surface of the cam arm with a tab portion of the base extending beyond the end of the cam arm. Trigger base portion and the cam arm exterior surface are disposed close to a front surface of component, such as only projecting 10 mm outwardly from the front surface, for forming the low profile of each latch assembly.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a perspective view not to scale illustrating a pair of low profile cam latch assemblies in a closed or locked and installed position in accordance with the preferred embodiment;

FIG. 2 is a perspective view not to scale illustrating the pair of low profile cam latch assemblies of FIG. 1 in an open position in accordance with the preferred embodiment;

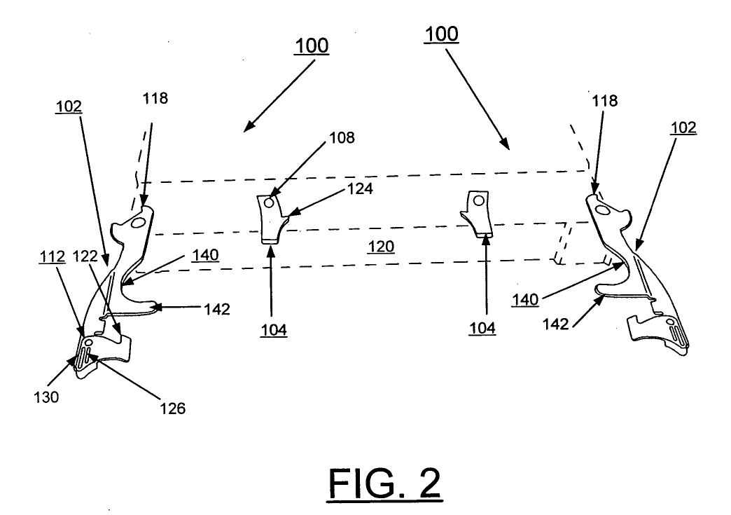

FIG. 3 is a perspective view not to scale illustrating one of the low profile cam latch assemblies of FIG. 1 in an open position showing a hook feature with a finger grip for easy extraction of a component in accordance with the preferred embodiment; and

FIGS. 4A and 4B are detail views illustrating respective ways to grip a latch trigger of the low profile cam latch assemblies of FIG. 1 in accordance with the preferred embodiment.

### DETAILED DESCRIPTION OF THE PREFERRED EMBODIMENTS

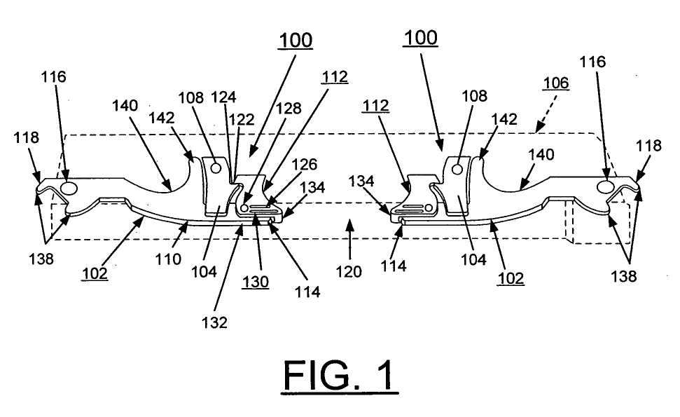

Having reference now to the drawings, in FIG. 1, there is shown a pair of low profile cam latch assemblies each generally designated by the reference character 100 in accordance with the preferred embodiment. Each low profile cam latch assembly 100 includes a cam arm or handle generally designated by the reference character 102 and a mating retainer 104. The mating retainer 104 is fixedly secured to an associated unit 106 shown in dotted line by a fastener 108, for example a rivet or screw, or other conventional mounting arrangement.

Cam arm or handle 102 includes an elongated, low profile arm 110 carrying a latch member or trigger 112 near a distal end 114. The trigger 112 is releasably engaged or spring mounted with the mating retainer 104 to retain or lock the cam arm 102 in the closed position shown in FIG. 1. Elongated low profile arm 110 is secured to the associated unit 106 at an anchor pivot point 116 near a proximal or cam end 118.

In accordance with features of the invention, cam latch assembly 100 is a low profile assembly having minimum depth of the latch, that it does not project out far from the front face of the component 106. For example, the cam latch assembly 100 only projects 10 mm from a front surface 120 of the associated unit or component 106, while a conventional standard latch projects out 31 mm. The low profile of assembly 100 is very advantageous for products in racks, because it allows more space for cable bend radii, essentially minimizing floor space. A low profile is becoming more important in products that have depth limitations, such as products for communication rack environments often having strict requirements on the overall depth of assemblies, and even a few millimeters less depth on latches becomes important. Cam latch assembly 100 advantageously is used with various types of associated units or components 106 including, for example, a blade server unit, a power supply, a switch, a blower, I/O, and other similar components.

It should be understood that the present invention is not limited to using a pair of low profile cam latch assemblies 100, a single cam latch assembly 100 advantageously is used with some of the associated units or components 106.

Positive retention of the cam arm or handle 110 is provided by the cam latch assembly 100. The cam arm 110 is held down with a locking tooth 122 of the spring mounted trigger 112 engaging a mating surface 124 of the retainer 104. The locking tooth 122 of the spring mounted trigger 112 clicks into place with audible and tactile indication that trigger 112 has seated with the mating retainer 104. The locked or engaged trigger 112 keeps the cam arm 110 from vibrating out of its locked or installed position.

Trigger 112 includes a grip feature 126 formed near an anchor pivot point 128 to the cam arm 110 in a base portion generally designated 130 of the trigger. Trigger base portion 130 extends generally parallel with an exterior surface 132 of the cam arm 110 with a tab portion 134 extending beyond the end 114 of the cam arm. Trigger base portion 130 and cam arm exterior surface 132 are disposed close to the front surface 120 of component 106, such as only projecting 10 mm outwardly from the front surface, for forming the low profile of each latch assembly 100.

The cam end 118 of the cam handle 110 near the pivot anchor point 138 has two rounded points 138 that serve to lever its attached component 106 into or out of a slot in a larger chassis. This feature is useful especially when electronic pin connections are being made on the rear of the attached component 106. Pin connections sometimes require insertion forces that would be difficult to achieve without the lever action that the cam handle 102 provides.

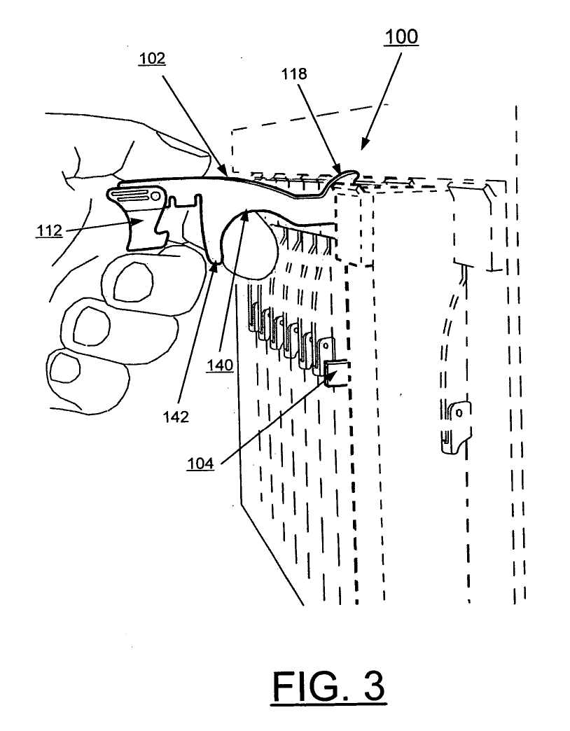

Referring also to FIG. 3, there is shown one assembly 100 in an open position of multiple low profile cam latch assemblies 100 illustrating a hook feature with a finger grip for easy extraction of a component in accordance with the preferred embodiment The cam handle 102 includes an easy pull finger shape or hook generally designated 140. Finger hook 140 has an unmistakable and inviting hook shape defined together with an outwardly extending flange or finger grip 142 with the cam handle 110 rotated out in preparation for removal of its attached component 106. The finger hook 140 invites a thumb or finger to wrap around it in a fluid motion after the trigger 112 is released from the retainer 104 and the cam handle 110 is rotated out of its locked/installed position. In addition, a contrasting color is added to the inside edge of this hook 140 so that the hook is further enhanced visually. This color and the hook shape 140 itself only becomes visible when the handle 110 is rotated out, so it does not confuse the user or vie for attention prior to the trigger 112 being released. The sequence of operation remains easy to understand.

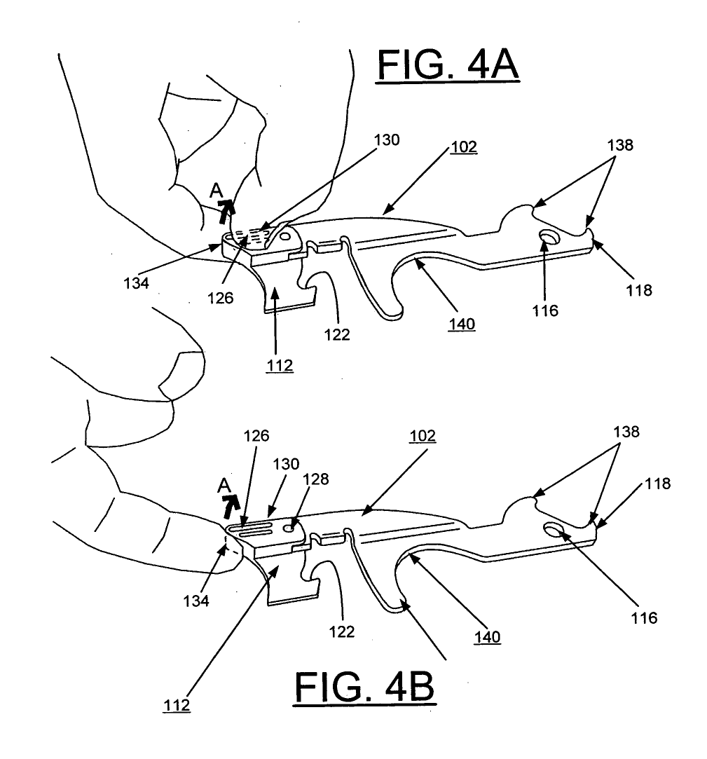

Referring also to FIGS. 4A, and 4B, the trigger 112 has two ways to easily be released. As shown in FIG. 4A, trigger 112 can be pulled as indicated by an arrow labeled A with a thumb and finger pinch grip using grip feature or relief ribs 126 formed into the sides of the trigger portion 130. Alternatively, as shown in FIG. 4B, trigger 112 lifted as indicated by an arrow labeled A with a single finger tip on the curved, pointed end portion 134. This feature adds versatility, allowing trigger 112 to be located in tight places or adjacent to bulkheads, cables, or other handles.

While the present invention has been described with reference to the details of the embodiments of the invention shown in the drawing, these details are not intended to limit the scope of the invention as claimed in the appended claims.

What is claimed is:

1. A cam latch assembly for use installation and removal of an associated component into a rack or chassis; said cam latch assembly comprising:
an elongated cam arm mounted to the associated component;
a mating retainer mounted to the associated component;
said elongated cam arm including a pivot mounted trigger member releasably engaged with the mating retainer to retain or lock the cam arm in a closed position;
said elongated cam arm including a recessed hook shape defined together with an outwardly extending finger grip; said finger hook shape and finger grip being arranged for engagement by a thumb or finger of a user with the cam arm rotated out in an open position for removal of the associated component.

2. A cam latch assembly as recited in claim 1 includes a contrasting color added to the finger hook shape to visually enhance said finger hook shape and said finger grip; said contrasting color and said finger hook shape being visible only when the cam arm is rotated out in the open position.

3. A cam latch assembly as recited in claim 1 wherein said trigger member includes a locking tooth for engaging a mating surface of the mating retainer.

4. A cam latch assembly as recited in claim 3 wherein said locking tooth of the trigger member clicks into place with audible and tactile indication that said trigger member has seated with said mating retainer in the closed position.

5. A cam latch assembly as recited in claim 3 wherein said engaged locking tooth of said trigger member keeps said cam arm from vibrating out of the closed position.

6. A cam latch assembly as recited in claim 1 wherein said trigger member includes a grip feature.

7. A cam latch assembly as recited in claim 6 wherein said grip feature is formed in a base portion of said trigger member near an anchor pivot point of said trigger member to said cam arm.

8. A cam latch assembly as recited in claim 7 wherein said base portion of said trigger member extends generally parallel with an exterior surface of said cam arm.

9. A cam latch assembly as recited in claim 8 wherein said base portion and said cam arm exterior surface are disposed close to a front surface of the associated component for forming a low profile of the cam latch assembly.

10. A cam latch assembly as recited in claim 8 wherein said base portion and said cam arm exterior surface project about 10 mm outwardly from a front surface of the associated component.

11. A cam latch assembly as recited in claim 7 wherein said base portion of said trigger member includes a tab portion extending beyond an end of the cam arm.

12. A cam latch assembly for use installation and removal of an associated component into a rack or chassis; said cam latch assembly comprising:
an elongated cam arm mounted to the associated component;
a mating retainer mounted to the associated component;
said elongated cam arm including a pivot mounted trigger member releasably engaged with the mating retainer to retain or lock the cam arm in a closed position;
said trigger member includes a grip feature; said grip feature being formed in a base portion of said trigger member near an anchor pivot point of said trigger member to said cam arm.

13. A cam latch assembly as recited in claim 12 wherein said base portion of said trigger member extends generally parallel with an exterior surface of said cam arm.

14. A cam latch assembly as recited in claim 13 wherein said base portion and said cam arm exterior surface are disposed close to a front surface of the associated component for forming a low profile of the cam latch assembly.

15. A cam latch assembly as recited in claim 13 wherein said base portion and said cam arm exterior surface project about 10 mm outwardly from a front surface of the associated component.

16. A cam latch assembly as recited in claim 12 wherein said elongated cam arm includes a recessed hook shape defined together with an outwardly extending finger grip; said finger hook shape and finger grip being arranged for engagement by a thumb or finger of a user with the cam arm rotated out in an open position for removal of the associated component.

17. A cam latch assembly as recited in claim 12 wherein said trigger member includes a locking tooth for engaging a mating surface of the mating retainer.

18. A cam latch assembly as recited in claim 17 wherein said wherein said locking tooth of the trigger member clicks into place with audible and tactile indication that said trigger member has seated with said mating retainer in the closed position.

19. A cam latch assembly as recited in claim 17 wherein said engaged locking tooth of said trigger member keeps said cam arm from vibrating out of the closed position.
